(19) United States
(12) Patent Application Publication
(10) Pub. No.: US 2013/0325234 A1
(43) Pub. Date: Dec. 5, 2013

(54) CONTROL DEVICE, CONTROL METHOD, AND CONTROL SYSTEM FOR HYBRID VEHICLE

(71) Applicant: Tomoyuki SHIBATA, Toyota-shi (JP)

(72) Inventor: Tomoyuki SHIBATA, Toyota-shi (JP)

(73) Assignee: TOYOTA JIDOSHA KABUSHIKI KAISHA, Toyota-shi (JP)

(21) Appl. No.: 13/903,275

(22) Filed: May 28, 2013

(30) Foreign Application Priority Data
Jun. 4, 2012 (JP) 2012-127178

(51) Int. Cl. B60W 20/00

(52) U.S. Cl. CPC B60W 20/106
USPC 701/22; 903/905

(57) ABSTRACT

A control device is applied to a hybrid vehicle on which an internal combustion engine equipped with a supercharger, and a motor generator that generates electric power while applying negative torque to the internal combustion engine, are installed. The control device drives a boost pressure varying mechanism so as to regulate a boost pressure developed by the supercharger, and drives a throttle valve of the engine so as to adjust its throttle opening. A controller of the control device drives the boost pressure varying mechanism to reduce the boost pressure of the supercharger, before driving the throttle valve to reduce the throttle opening, in order to reduce output torque of the engine, when the motor generator is in a. high-load condition while negative torque applied from the motor generator to the engine is adjusted so as to restrict the engine speed to a target value.

### INCORPORATION BY REFERENCE

The disclosure of Japanese Patent Application No. 2012-127178 filed on Jun. 4, 2012 including the specification, drawings and abstract is incorporated herein by reference in its entirety.

### BACKGROUND OF THE INVENTION

1. Field of the Invention

The invention relates to a control device, a control method, and a control system for a hybrid vehicle.

2. Description of Related Art

A hybrid vehicle as shown in Japanese Patent Application Publication No. 2007-314127 (JP 2007-314127 A) is installed with an internal combustion engine equipped with a supercharger, and a motor generator that generates electric power while applying torque (negative torque) to the internal combustion engine in such a direction as to suppress rotation of the engine. In this type of hybrid vehicle, a boost pressure varying mechanism is driven so as to regulate the boost pressure developed by the supercharger of the engine, and a throttle valve of the engine is driven so as to adjust the throttle opening.

In the hybrid vehicle as described above, the output torque of the internal combustion engine is controlled to a currently required value, through control of the boost pressure and the throttle opening in the engine. More specifically, the boost pressure and the throttle opening are controlled, so that the amount of air supplied into each cylinder of the engine is controlled, and fuel is supplied into the cylinder in an amount corresponding to the controlled amount of air. Accordingly, if the amount of air supplied into each cylinder of the engine is controlled through control of the boost pressure and the throttle opening, the amount of air-fuel mixture in the cylinder of the engine is controlled in accordance with the amount of air, and the output torque of the engine produced based on combustion of the air-fuel mixture is controlled.

In the hybrid vehicle, if the motor generator is operated as a generator while the internal combustion engine is being operated, negative torque is applied from the motor generator to the engine. Therefore, the motor generator is able to generate electric power, while regulating the engine speed to a target value through control of the output torque of the engine and the negative torque produced by the motor generator.

In the meantime, when the output torque of the engine becomes excessively large due to changes in engine operating conditions, for example, the negative torque applied to the engine is increased so as to restrict the engine speed to the target value, and the motor generator that produces the negative torque is brought into a high-load condition. If the motor generator is placed in a high-load condition due to the excess output torque of the engine, the motor generator is likely to rotate at a high speed.

In this connection, the maximum value of negative torque that can be applied from the motor generator to the engine varies depending on driving conditions of the motor generator, such as the rotational speed of the motor generator during power generation. More specifically, as the rotational speed of the motor generator that operates as a generator increases, the maximum value of negative torque that can be applied from the motor generator to the engine tends to be reduced.

If the motor generator is brought into a high-load, high-rotational-speed condition as described above, due to the excess output torque of the engine, and the maximum value of negative torque that can be applied from the motor generator to the engine is reduced, the following phenomenon may take place. Namely, even if the maximum value of negative torque is applied from the motor generator to the engine, the engine speed cannot be restricted to the target value, and the engine speed deviates to the higher side from the target value.

In JP 2007-314127 A, Japanese Patent Application Publication No. 2003-111206 (JP 2003-111206 A), and Japanese Patent Application Publication No. 11-55810 (JP 11-55810 A), it is proposed to reduce the output torque of the internal combustion engine when the temperature of the motor generator that applies negative torque to the engine is high. The motor generator is brought into a high-temperature condition in certain situations, such as a situation where the motor generator that operates as a generator is brought into a high-load, high-rotational-speed condition. A control system described in JP 2003-111206 A is configured to reduce negative torque applied from the motor generator to the engine when the temperature of the motor generator is high, thereby to reduce the load of the motor generator and reduce the temperature of the motor generator. Then, the output torque of the engine is reduced so as to suppress increase of the engine speed due to reduction of the negative torque produced by the motor generator as described above.

If the output torque of the internal combustion engine is reduced as described in JP 2007-314127 A, JP 2003-111206 A, and JP 11-55810 A when the temperature of the motor generator is raised due to a high-load, high-rotational-speed condition of the motor generator, negative torque required to be applied from the motor generator to the engine so as to restrict the engine speed to the target value can be reduced. With the negative torque of the motor generator thus reduced so as to restrict the engine speed to the target value, the load of the motor generator is suppressed or reduced, and the rotational speed of the motor generator is also suppressed or reduced. As a result, the following phenomenon is less likely to occur or prevented from occurring due to the high-load, high-rotational-speed condition of the motor generator. Namely, the engine speed can be prevented from deviating to the higher side from the target value, in a situation where the negative torque applied from the motor generator to the engine is not large enough to restrict the engine speed to the target value.

As a method of reducing the output torque of the engine when the temperature of the motor generator is high, it is proposed in JP 2007-314127 A to reduce the boost pressure developed by the supercharger of the engine. While no method of reducing the output torque of the engine when the temperature of the motor generator is high is clearly described in JP 2003-111206 A and JP 11-55810 A, it is presumed to reduce the output torque of the engine by reducing the throttle opening, since no supercharger is provided in the engine.

In the internal combustion engine equipped with the supercharger, the boost pressure may be reduced or the throttle opening may be reduced as described above, as methods of reducing the output torque of the engine when the temperature of the motor generator is high; however, the manner of selecting one from these methods and the order of execution of the methods have not been sufficiently studied. Therefore, the output torque of the engine may not be adequately reduced, depending on the selected method of reducing the output torque of the engine, the order of execution of the methods, or the like. For example, it may be proposed to select reduction of the throttle opening as one of the methods of reducing the output torque of the engine. However, under a situation where the boost pressure is high, even if the throttle opening is reduced, the amount of air supplied into the cylinders of the engine is less likely to be reduced; therefore, the output torque of the engine cannot be adequately reduced by reducing the throttle opening.

### SUMMARY OF THE INVENTION

The invention provide a control device, a control method, and a control system of a hybrid vehicle, which can adequately reduce output torque of an internal combustion engine equipped with a supercharger so as to reduce or eliminate a deviation of the engine speed from a target value, when the engine speed deviates to the higher side from the target value even if negative torque is applied from a motor generator to the engine.

When a motor generator is operated as a generator, during operation of an internal combustion engine equipped with a supercharger, negative torque produced by the motor generator is applied to the internal combustion engine. At this time, the output torque of the engine and the negative torque of the motor generator are controlled, so that the engine speed can be regulated to a target value. However, if the output torque of the engine becomes excessively large while the engine speed is being controlled, negative torque applied from the motor generator to the engine so as to restrict the engine speed to the target value is increased, and the motor generator is brought into a high-load condition. If the motor generator is placed in the high-load condition, the motor generator is likely to rotate at a high speed. As the rotational speed of the motor generator increases, the maximum value of negative torque that can be applied from the motor generator to the engine is reduced. Accordingly, when the motor generator is in the high-load condition, the engine speed may not be restricted to the target value even if the maximum value of negative torque is applied from the motor generator to the engine, and the engine speed may deviate to the higher side from the target value.

In order to deal with the deviation of the engine speed from the target value, according to the first aspect of the invention, the control device for hybrid vehicle comprises a controller. The controller is configured to drive the boost pressure varying mechanism to reduce the boost pressure of the supercharger, before driving the throttle valve to reduce the throttle opening, in order to reduce output torque of the internal combustion engine, when the motor generator is in a high-load condition while negative torque applied from the motor generator to the internal combustion engine is adjusted so as to restrict an engine speed of the internal combustion engine to a target value.

In the above arrangement, the boost pressure is initially reduced so that the amount of air supplied into cylinders of the engine is reduced, whereby the output torque of the engine is reduced. With the output torque of the engine thus reduced, the negative torque applied from the motor generator to the engine so as to restrict the engine speed to the target value is less likely to be increased, in other words, the motor generator is less likely to be or prevented from being brought into a high-load condition. As a result, the rotational speed of the motor generator is less likely to be or prevented from being increased due to the high-load condition of the motor generator, and the maximum value of negative torque that can be applied from the motor generator to the engine is less likely to be or prevented from being reduced as the rotational speed increases. Accordingly, the engine speed is less likely to deviate or prevented from deviating to the higher side from the target value, the engine speed cannot be regulated to the target value even if the maximum value of negative torque is applied from the motor generator to the engine.

Even if the output torque of the engine is reduced due to reduction of the boost pressure, the engine speed may not be completely prevented from deviating to the higher side from the target value due to the negative torque applied from the motor generator to the engine. In this case, the throttle opening is reduced so that the output torque of the engine is further reduced. The throttle opening is reduced under a condition where the boost pressure is reduced as described above. With this arrangement, it is possible to reduce or eliminate a possibility that the amount of air supplied into the cylinders of the engine is less likely to be reduced when the throttle opening is reduced under a condition where the boost pressure is high, and the output torque of the engine cannot be adequately reduced due to the reduction of the throttle opening.

If the amount of air supplied into the cylinders of the engine is reduced due to the reduction of the throttle opening as described above, the output torque of the engine is adequately reduced. With the output torque of the engine thus reduced, the negative torque applied from the motor generator to the engine so as to restrict the engine speed to the target value is less likely to be increased, in other words, the motor generator is less likely to be or prevented from being brought into a high-load condition. As a result, the rotational speed of the motor generator is less likely to be or prevented from being increased due to the high-load condition of the motor generator, and the maximum value of negative torque that can be applied from the motor generator to the engine is less likely to be or prevented from being reduced as the above-indicated rotational speed increases. Accordingly, the engine speed is less likely to deviate or prevented from deviating to the higher side from the target value, in a situation where the engine speed cannot be regulated to the target value even if the maximum value of negative torque is applied from the motor generator to the engine.

In the manner as described above, when the engine speed deviates to the higher side from the target value even if the negative torque is applied from the motor generator to the engine equipped with the supercharger, the output torque of the engine can be adequately reduced so as to reduce or eliminate the deviation. With the output torque of the engine thus reduced, the motor generator is less likely to be or prevented from being in a high-load condition, and the rotational speed of the motor generator is less likely to increase or prevented from increasing due to the high-load condition. Accordingly, the maximum value of negative torque that can be applied from the motor generator to the engine is less likely to be or prevented from being reduced as the rotational speed of the motor generator increases, and the above-described deviation of the engine speed when the negative torque is applied to the engine can be reduced or eliminated.

In the control device for the hybrid vehicle described above, the controller may be configured to determine that the motor generator is in the high-load condition when the negative torque applied from the motor generator to the internal combustion engine is equal to a maximum value thereof.

In the control device for the hybrid vehicle described above, the controller may be configured to drive the boost pressure varying mechanism to reduce the boost pressure, so as to suppress a deviation of the engine speed to a higher side from the target value, when the motor generator is in the high-load condition. Further the controller may be configured to drive the boost pressure varying mechanism so as to hold the engine speed at the target value, after the deviation of the engine speed to the higher side from the target value is suppressed due to reduction of the boost pressure.

When the motor generator is in the high-load condition as described above, the controller may be configured to drive the throttle valve to reduce the throttle opening, after driving the boost pressure varying mechanism to reduce the boost pressure.

If the motor generator is brought into a high-load condition while the negative torque applied from the motor generator to the engine is being controlled so as to restrict the engine speed to the target value, the controller is configured to drive the boost pressure varying mechanism to reduce the boost pressure. In some cases, however, the engine speed may not be completely prevented from deviating from the target value even if the boost pressure varying mechanism is driven to reduce the boost pressure so as to reduce the output torque of the engine. In this case, the controller may be configured to drive the throttle valve to reduce the throttle opening so as to suppress the deviation of the engine speed to the higher side from the target value, after driving the boost pressure varying mechanism to reduce the boost pressure. Further the controller may be configured to drive the throttle valve so as to hold the engine speed at the target value, after the deviation of the engine speed to the higher side from the target value is suppressed due to reduction of the throttle opening. I Accordingly, the engine speed can be adequately made equal to the target value.

The hybrid vehicle may be equipped with a differential gear device including a planetary gear train comprising a planetary gear, a sun gear, and a ring gear, as three rotary elements, and the three rotary elements of the planetary gear train may be coupled with the internal combustion engine, motor generator, and a drive shaft of the vehicle, respectively. Namely, one of the three rotary elements is coupled with the engine such that rotary motion can be transmitted therebetween, and another one of the three rotary elements is coupled with the motor generator such that rotary motion can be transmitted therebetween, while a remaining one of the three rotary elements is coupled with the drive shaft of the vehicle such that rotary motion can be transmitted therebetween. In this case, the controller may be configured to control a magnitude of the negative torque applied from the motor generator to the internal combustion engine so that the engine speed becomes equal to the target value.

According to the second aspect of the invention, a control method for a hybrid vehicle comprises: driving a boost pressure varying mechanism of the internal combustion engine so as to regulate a boost pressure developed by the supercharger of the internal combustion engine; and driving a throttle valve of the internal combustion engine so as to adjust a throttle opening thereof. The hybrid vehicle on which an internal combustion engine equipped with a supercharger, and a motor generator that generates electric power while applying negative torque to the internal combustion engine, are installed. The boost pressure varying mechanism is driven to reduce the boost pressure of the supercharger, before the throttle valve is driven to reduce the throttle opening, in order to reduce output torque of the internal combustion engine, when the motor generator is in a high-load condition while negative torque applied from the motor generator to the internal combustion engine is adjusted so as to restrict an engine speed of the internal combustion engine to a target value.

According to the third aspect of the invention, a control system for a hybrid vehicle comprises a boost pressure varying mechanism configured to regulate a boost pressure developed by the supercharger, a throttle valve configured to control a throttle opening thereof; and a controller. The hybrid vehicle on which an internal combustion engine equipped with a supercharger, and a motor generator that generates electric power while applying negative torque to the internal combustion engine, are installed. The controller configured to drive the boost pressure varying mechanism to reduce the boost pressure of the supercharger, before driving the throttle valve to reduce the throttle opening, in order to reduce output torque of the internal combustion engine, when the motor generator is in a high-load condition while negative torque applied from the motor generator to the internal combustion engine is adjusted so as to restrict an engine speed of the internal combustion engine to a target value.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view schematically illustrating the construction of a hybrid vehicle to which a control device of the invention is applied;

FIG. 2 is a control block diagram illustrating the outlines of processing for driving control of an internal combustion engine and a first motor generator;

FIG. 3 is a graph indicating patterns of change in driver-requested torque with respect to changes in the vehicle speed and the accelerator operation amount;

FIG. 4 is a graph indicating a pattern of change in charge/discharge required power with respect to changes in the state of charge of a battery;

FIG. 5 is a graph indicating combinations of the output torque and the engine speed when the internal combustion engine is operated at the optimum fuel efficiency;

FIG. 6 is a view useful for explaining the relationships among negative torque produced by the first motor generator, output torque of the internal combustion engine, engine speed, and torque generated from a drive shaft;

FIG. 7 is a flowchart illustrating the procedure of reducing the output torque of the internal combustion engine; and

FIG. 8 is a graph indicating patterns of change in the maximum value of negative torque produced by the first motor generator, which changes according to the rotational speed of the first motor generator, and boosted voltage for operating the first motor generator.

### DETAILED DESCRIPTION OF EMBODIMENTS

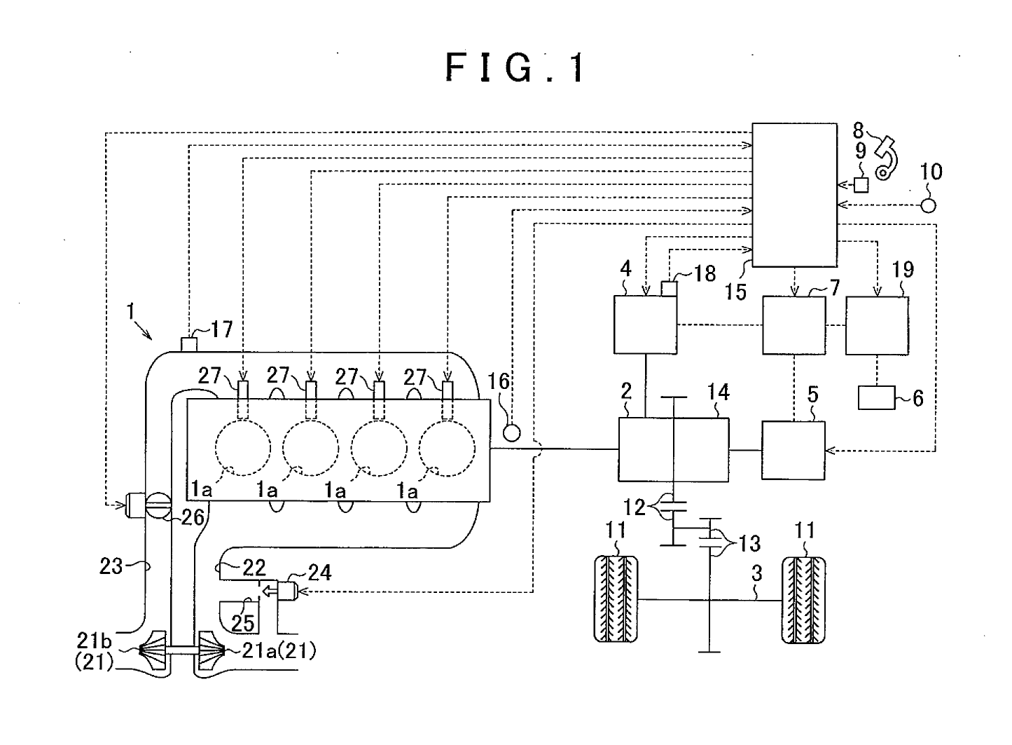

One embodiment of the invention in the form of a control device of a hybrid vehicle on which an internal combustion engine and motors are installed as prime movers will be described with reference to FIG. 1-FIG. 8. As shown in FIG. 1, the internal combustion engine 1 (which may be simply called “engine”) installed on the hybrid vehicle is equipped with a turbocharger 21 as a supercharger. The turbocharger 21 includes a turbine wheel 21a that rotates due to flow of exhaust gas that flows through an exhaust passage 22 of the engine 1, and a compressor wheel 21b that rotates as a unit with the turbine wheel 21a so as to send air in an intake passage 23 of the engine 1 into combustion chambers 1a of the engine 1.

The internal combustion engine 1 is also provided with a waste gate valve 24 as a boost pressure varying mechanism that makes the pressure within the intake passage 23, i.e., the boost pressure developed by the turbocharger 21, variable. The waste gate valve 24 is mounted at a bypass passage 25 that bypasses the turbine wheel 21a of the turbocharger 21 in the exhaust passage 22, and the opening of the waste gate valve 24 is adjusted so that the flow passage area of exhaust gas in the bypass passage 25 can be varied. The boost pressure developed by the turbocharger 21 of the engine 1 is reduced as the opening of the waste gate valve 24 is increased so as to reduce the amount of exhaust gas flowing toward the turbine wheel 21a. To the contrary, the boost pressure is increased as the opening of the waste gate valve 24 is reduced so as to increase the amount of exhaust gas flowing toward the turbine wheel 21a.

A throttle valve 26 is disposed downstream of the compressor wheel 21b in the intake passage 23 of the engine 1. The opening of the throttle valve 26 is adjusted so as to make the flow passage area of air in the intake passage 23 variable. In the internal combustion engine 1, the amount of air supplied from the intake passage 23 to each combustion chamber 1a of the engine 1 can be regulated through adjustment of the opening of the throttle valve 26, and fuel is injected from a corresponding fuel injection valve 27 in an amount corresponding to the amount of air, to be supplied to the combustion chamber 1a. Thus, the amount of air-fuel mixture that consists of air and fuel, in each combustion chamber 1a of the engine 1, is regulated through adjustment of the opening of the throttle valve 26, and, consequently, the output torque of the engine 1 produced by combustion of the air-fuel mixture is controlled.

A power split device 2 is provided for splitting or dividing power generated from the engine 1, into power transmitted to a drive shaft 3 of the hybrid vehicle via countershaft gears 12 and final reduction gears 13, and power transmitted to a first motor generator 4. As the power split device 2, a differential gear device having a planetary gear train including a planetary gear, sun gear, and a ring gear, is employed. In the planetary gear train of the power split device 2, the planetary gear is coupled with the engine 1 such that rotary motion can be transmitted therebetween, and the sung gear is coupled with the first motor generator 4 such that rotary motion can be transmitted therebetween, while the ring gear is coupled with the drive shaft 3 via the countershaft gears 12 and the final reduction gears 13 such that rotary motion can be transmitted therebetween.

Also, power generated from a second motor generator 5 is transmitted to the drive shaft 3 of the hybrid vehicle, via a reduction gear mechanism 14 including a planetary gear train, countershaft gears 12, and the final reduction gears 13. With power transmitted to the drive shaft 3, wheels 11 linked with the drive shaft 3 rotate, whereby the hybrid vehicle runs. The planetary gear train of the reduction gear mechanism 14 has a sun gear that is coupled with the second motor generator 5 such that rotary motion can be transmitted therebetween, a ring gear that is coupled with the ring gear of the planetary gear train of the power split device 2 such that the ring gears are rotatable as a unit, and a planetary gear that is fixed so as not to revolve relative to the sun gear and ring gear of the planetary gear train of the reduction gear mechanism 14.

The first motor generator 4 mainly functions as a generator, but may also function as a motor, depending on operating conditions of the hybrid vehicle, such as when the engine 1 is started. The second motor generator 5 mainly functions as a motor, but may also function as a generator, depending on operating conditions of the hybrid vehicle, such as when the vehicle is decelerated. The hybrid vehicle is provided with an inverter 7 and a converter 19, which control input and output of electric power between a battery 6 and the first and second motor generators 4, 5. The inverter 7 and converter 19 are operable to supply electric power generated by the first motor generator 4 that mainly functions as a generator, to the battery 6, so as to charge the battery 6, and supply electric power from the battery 6 or the first motor generator 4 to the second motor generator 5 that mainly functions as a motor.

The hybrid vehicle is provided with an electronic control unit 15 that controls various devices installed on the vehicle. The electronic control unit 15 includes CPU that performs computations associated with control of the above-mentioned various devices, ROM in which programs and data necessary for the control are stored, RAM in which the results of computations of the CPU, etc., are temporarily stored, input and output ports through which signals are transmitted to and received from the outside, and so forth.

An accelerator position sensor 9 that detects the amount (accelerator operation amount) of operation of an accelerator pedal 8 operated by the driver of the hybrid vehicle, and a vehicle speed sensor 10 that detects the running speed (vehicle speed) of the hybrid vehicle, are connected to the input port of the electronic control unit 15. Further, a crank position sensor 16 that outputs a signal corresponding to rotation of the crankshaft of the engine 1, a pressure sensor 17 that detects the intake pressure (boost pressure) of the, engine 1, and a rotational speed sensor 18 that detects the rotational speed of the first motor generator 4, are also connected to the input port.

To the output port of the electronic control unit 15 are connected drive circuits of various devices for operating the engine 1, namely, a drive circuit of the fuel injection valves 27, a drive circuit of the throttle valve 26, a drive circuit of the waste gate valve 24, etc. Further, a drive circuit of the first motor generator 4, a drive circuit of the second motor generator 5, a drive circuit of the inverter 7, and a drive circuit of the converter 19 are also connected to the output port.

The electronic control unit 15 calculates vehicle required power Pt, based on operating conditions, such as the vehicle speed V and the accelerator operation amount ACCP, and the state of charge SOC of the battery 6, and controls power generated from the engine 1 and power generated from the second motor generator 5 so that the vehicle required power Pt can be obtained. At this time, the first motor generator 4 operated by the engine 1 functions as a generator, to generate electric power for driving the second motor generator 5, etc. and charging the battery 6. The driving control of the engine 1, first motor generator 4, and the second motor generator 5 in the vehicle is performed in an attempt to minimize energy consumption in the vehicle as a whole.

Next, operations executed by the electronic control unit 15, when performing driving control of the internal combustion engine 1, first motor generator 4, and the second motor generator 5 in the vehicle, will be described.

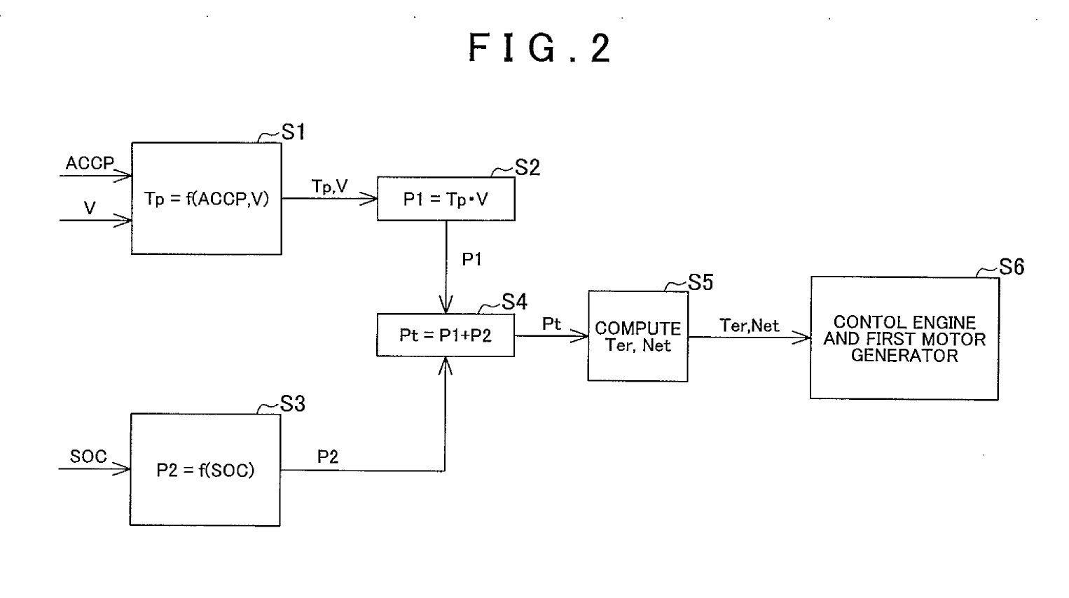

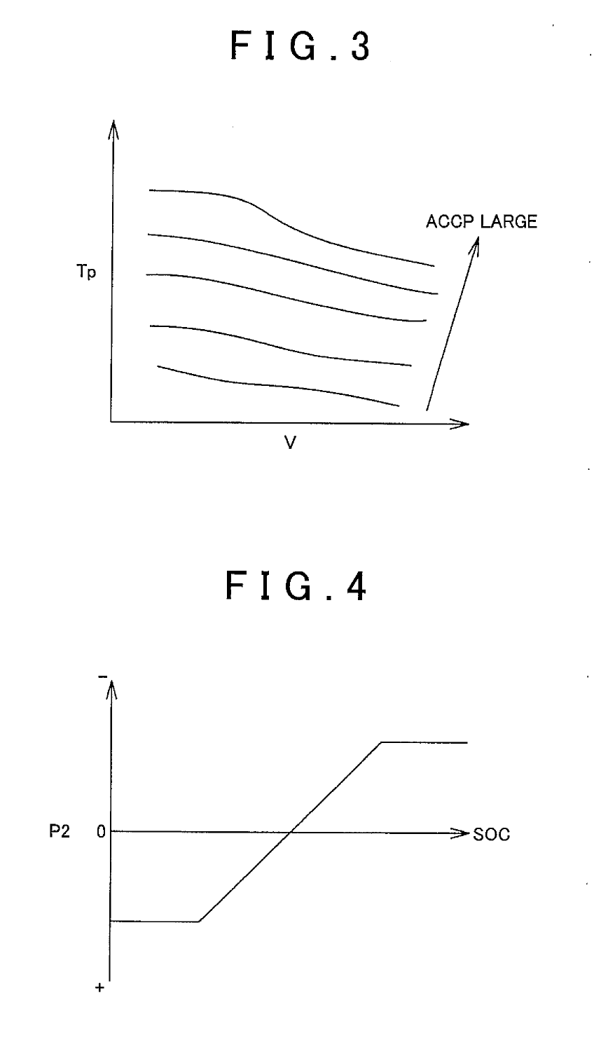

FIG. 2 is a control block diagram schematically showing a series of operations (S1-S5) for controlling driving of the internal combustion engine 1 and the first motor generator 4. Initially, driver-requested torque Tp as output torque from the drive shaft 3 of the vehicle, which is requested by the driver, is calculated, based on the accelerator operation amount ACCP and the vehicle speed V (S1). The thus calculated driver-requested torque Tp changes as shown in FIG. 3, for example, with respect to changes in the vehicle speed V and the accelerator operation amount ACCP. Then, running power P1 as power of the engine 1 required for running the vehicle according to the driver's request is calculated, based on the driver-requested torque Tp and the vehicle speed V (S2).

On the other hand, as shown in FIG. 2, charge/discharge required power P2 as power of the engine 1 required for operating the first motor generator 4 to generate electric power is calculated, based on the state of charge SOC of the battery 6 (S3). The thus calculated charge/discharge required power P2 changes as shown in FIG. 4, for example, with respect to changes in the state of charge SOC. Then, as shown in FIG. 2, the vehicle required power Pt is calculated by summing the charge/discharge required power P2 and the above-mentioned running power P1 (S4). The vehicle required power Pt is the total value of power required to be generated from the engine 1 in the vehicle as a whole. Once the vehicle required power Pt is calculated, a required value Ter of output torque Te of the engine 1, and a target value Net of the engine speed Ne, for causing the engine 1 to generate power corresponding to the vehicle required power Pt, are calculated (S5).

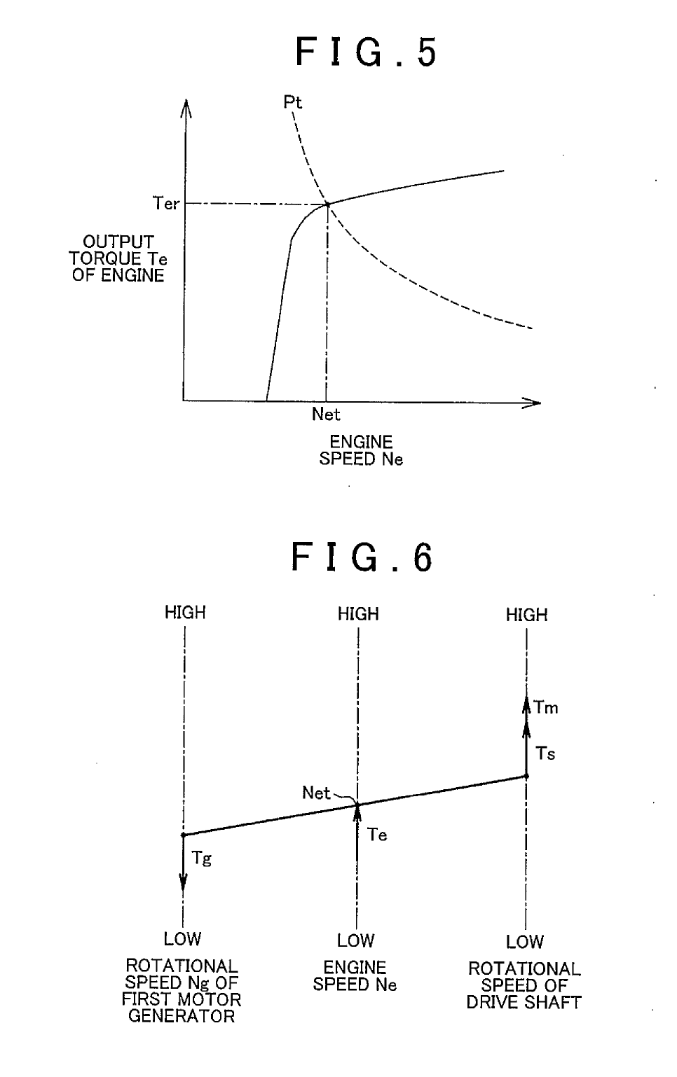

In this connection, the power of the internal combustion engine 1 is determined by a combination of the output torque Te and engine speed Ne of the engine 1. The combination (operating point) of the output torque Te and the engine speed Ne, which optimizes the fuel efficiency of the engine 1, changes along a solid line (optimum fuel efficiency line) of FIG. 5, for example, with respect to changes in the power of the engine 1. In FIG. 5, the vehicle required power Pt is indicated by a broken line. The broken line indicating the vehicle required power Pt changes as follows, for example, in accordance with the magnitude of the vehicle required power Pt. Namely, the broken line shifts toward the origin of the graph of FIG. 5 as the vehicle required power Pt decreases, while the broken line shifts away from the origin of the graph of FIG. 5 as the vehicle required power Pt increases. In the operation of S5 of FIG. 2, an operating point, or a combination of the output torque Te and the engine speed Ne, at which the broken line indicating the vehicle required power Pt and the optimum fuel efficiency line (solid line) intersect with each other in FIG. 5, is determined. Then, the output torque Te of this combination is calculated as the required value Ter of output torque Te of the engine 1, and the engine speed Ne of the combination is calculated as the target value Net of the engine speed Ne.

Through the operations of S1-S5 in FIG. 2, the required value Ter thus calculated is determined based on the driver's accelerator operation amount ACCP, etc. Once the required value Ter of the output torque Te of the engine 1 and the target value Net of the engine speed Ne are calculated through the operation of S5, driving control of the engine 1, for example, control of the throttle opening in the engine 1, is performed so that the output torque Te of the engine 1 becomes equal to the required value Ter. While the output torque Te of the engine 1 is controlled to the required value Ter through the driving control of the engine 1, driving control (feedback control) of the first motor generator 4 that functions as a generator is performed so that the engine speed Ne becomes equal to the target value Net under this situation. Namely, the magnitude of negative torque Tg applied from the first motor generator 4 to the engine 1 in such a direction as to suppress rotation of the engine is controlled, so that the engine speed Ne obtained based on the detection signal of the crank position sensor 16 becomes equal to the target value Net.

FIG. 6 shows the relationships among the output torque Te, engine speed Ne, and the negative torque Tg when the output torque Te of the engine 1 is controlled to the required value Ter while the engine speed Ne is controlled to the target value Net. The output torque Te of the engine 1 is controlled to the required value Ter, such that the magnitude of the negative torque Tg required for restricting the engine speed Ne to the target value Net increases as the output torque Te increases. In this connection, when the internal combustion engine 1 is in steady operation under conditions where the output torque Te is controlled to the required value Ter while the engine speed Ne is controlled to the target value Net, the relationship expressed by the following equation: Te=−{(1+ρ)/ρ}·Tg is established between the output torque Te and the negative torque Tg. In this equation, “ρ” represents the ratio of the number of teeth of the sun gear to that of the ring gear in the planetary gear train of the power split device 2.

Under the conditions where the output torque Te is controlled to the required value Ter while the engine speed Ne is controlled to the target value Net, torque Ts transmitted from the engine 1 side to the drive shaft 3 is represented by the following equation: Ts={1/(1+ρ)}·Te. If the torque Ts falls short of the driver-requested torque Tp, driving of the second motor generator 5 is controlled so that a shortfall in torque Ts relative to the driver-requested torque Tp is generated from the second motor generator 5. Torque Tm transmitted from the second motor generator 5 side to the drive shaft 3 of the vehicle at this time is represented by the following equation: Tm=Tp−Ts. The output torque of the second motor generator 5 is controlled through driving control of the second motor generator 5 so that the torque Tm can be obtained, whereby the output torque from the drive shaft 3 of the vehicle is made equal to the driver-requested torque Tp.

Next, control of the boost pressure developed by the turbocharger 21 of the engine 1, which control is performed by the electronic control unit 15, will be described. In the control of the boost pressure, a target boost pressure is calculated based on engine operating conditions, such as the output torque Te and engine speed Ne of the engine 1. It is possible to employ the required value Ter of the output torque Te of the engine 1, which is determined based on the vehicle required power Pt, as the output torque Te of the engine 1. Then, the waste gate valve 24 is driven so that the actual boost pressure of the engine 1 is made equal to the thus obtained target boost pressure.

When the output torque Te of the engine 1 becomes excessively large, due to changes in the engine operating conditions, for example, the negative torque Tg applied from the first motor generator 4 to the engine 1 so as to restrict the engine speed Ne to the target value Net is increased, and the first motor generator 4 is brought into a high-load condition. When the first motor generator 4 is placed in a high-load condition due to the excess output torque Te of the engine 1, the first motor generator 4 is likely to rotate at a high speed.

In this connection, the maximum value Tgm of the negative torque Tg of the first motor generator 4, which can be applied to the engine 1, changes according to driving conditions of the first motor generator 4, such as the rotational speed Ng of the first motor generator 4 during power generation. More specifically, as the rotational speed Ng of the first motor generator 4 that operates as a generator increases, the maximum value Tgm of the negative torque Tg that can be applied from the first motor generator 4 to the engine 1 tends to be reduced.

If the first motor generator 4 is brought into a high-load, high-rotational-speed condition as described above, due to the excess output torque Te of the engine 1, and the maximum value Tgm of the negative torque Tg that can be applied from the first motor generator 4 to the engine 1 is reduced, the following phenomenon may take place. Namely, even if the maximum value Tgm of the negative torque Tg produced by the first motor generator 4 is applied to the engine 1, the engine speed Ne cannot be reduced down to the target value Ne, and the engine speed Ne deviates to the higher side from the target value Net. In this embodiment, in order to deal with the deviation of the engine speed Ne, the output torque Te of the engine 1 is reduced in the following manner, when the first motor generator 4 is brought into a high-load condition while the negative torque Tg applied from the first motor generator 4 to the engine 1 is controlled so as to regulate the engine speed Ne to the target value Ne. Namely, the waste gate valve 24 is driven so as to reduce the boost pressure developed by the turbocharger 21 of the engine 1, before the throttle valve 26 is driven so as to reduce the throttle opening of the engine 1. The reduction of the boost pressure and the reduction of the throttle opening lead to reduction of the output torque Te of the engine 1.

It is determined that the first motor generator 4 is in a high-load condition, based on a condition that the negative torque Tg applied from the first motor generator 4 to the engine 1 becomes equal to the maximum value Tgm. Since the maximum value Tgm is a value determined by operating conditions of the first motor generator 4 as the upper limit of the negative torque Tg, this value Tgm may be obtained based on the operating conditions, etc.

Next, the operation of the control device of the hybrid vehicle according to this embodiment will be described. When the negative torque Tg applied from the first motor generator 4 to the internal combustion engine 1 is controlled so as to regulate the engine speed Ne to the target value Net, the output torque Te of the engine 1 is reduced in the following manner if the first motor generator 4 is brought into a high-load condition.

Initially, the boost pressure is lowered so that the amount of air supplied into the cylinders of the engine 1 is reduced, whereby the output torque Te of the engine 1 is reduced: With the output torque Te of the engine 1 thus reduced, the negative torque Tg applied from the first motor generator 4 to the engine 1 so as to restrict the engine speed Ne to the target value Net is less likely to be increased, in other words, the first motor generator 4 is less likely to be or prevented from being brought into a high-load condition. As a result, the rotational speed Ng of the first motor generator 4 is less likely to be or prevented from being increased due to the high-load condition of the first motor generator 4, and the maximum value Tgm of the negative torque Tg applied from the first motor generator 4 to the engine 1 is less likely to be or prevented from being reduced as the rotational speed Ng increases. Accordingly, the engine speed Ne is less likely to deviate or prevented from deviating to the higher side from the target value Net, in a situation where the engine speed Ne cannot be regulated to the target value Net even if the maximum value Tgm of the negative torque Tg is applied from the first motor generator 4 to the engine 1.

Even if the output torque Te of the engine 1 is reduced due to reduction of the boost pressure, the engine speed Ne may not be completely prevented from deviating to the higher side from the target value Net due to the negative torque Tg applied from the first motor generator 4 to the engine 1. In this case, the throttle opening is reduced so that the output torque Te of the engine 1 is further reduced. The throttle opening is reduced under a condition where the boost pressure is reduced as described above. Accordingly, it is possible to avoid an otherwise possible situation where the amount of air supplied into the cylinders of the engine 1 is less likely to be reduced since the throttle opening is reduced while the boost pressure is high, and the output torque Te of the engine 1 cannot be adequately reduced due to reduction of the throttle opening.

If the amount of air supplied into the cylinders of the engine 1 is reduced due to the reduction of the throttle opening, the output torque Te of the engine 1 is adequately reduced. With the output torque Te of the engine 1 thus reduced, the negative torque Tg applied from the first motor generator 4 to the engine 1 so as to restrict the engine speed Ne to the target value Net is less likely to be increased, in other words, the first motor generator 4 is less likely to be or prevented from being brought into a high-load condition. As a result, the rotational speed Ng of the first motor generator 4 is less likely to be or prevented from being increased due to the high-load condition of the first motor generator 4, and the maximum value Tgm of the negative torque Tg that can be applied from the first motor generator 4 to the engine 1 is less likely to be or prevented from being reduced as the rotational speed Ng increases. Accordingly, the engine speed Ne is less likely to deviate or prevented from deviating to the higher side from the target value Net, in a situation where the engine speed Ne cannot be regulated to the target value Net even if the maximum value Tgm of the negative torque Tg is applied from the first motor generator 4 to the engine 1.

In the manner as described above, when the engine speed Ne deviates to the higher side from the target value Net even if the negative torque Tg is applied from the first motor generator 4 to the engine 1, the output torque Te of the engine 1 can be adequately reduced so as to reduce or eliminate the deviation. With the output torque Te of the engine 1 thus reduced, the first motor generator 4 is less likely to be or prevented from being in a high-load condition, and the rotational speed Ng of the first motor generator 4 is less likely to increase or prevented from increasing due to the high-load condition. Accordingly, the maximum value Tgm of the negative torque Tg that can be applied from the first motor generator 4 to the engine 1 is less likely to be or prevented from being reduced as the rotational speed Ng of the first motor generator 4 increases, and the above-described deviation of the engine speed Ne when the negative torque Tg is applied to the engine 1 can be reduced or eliminated.

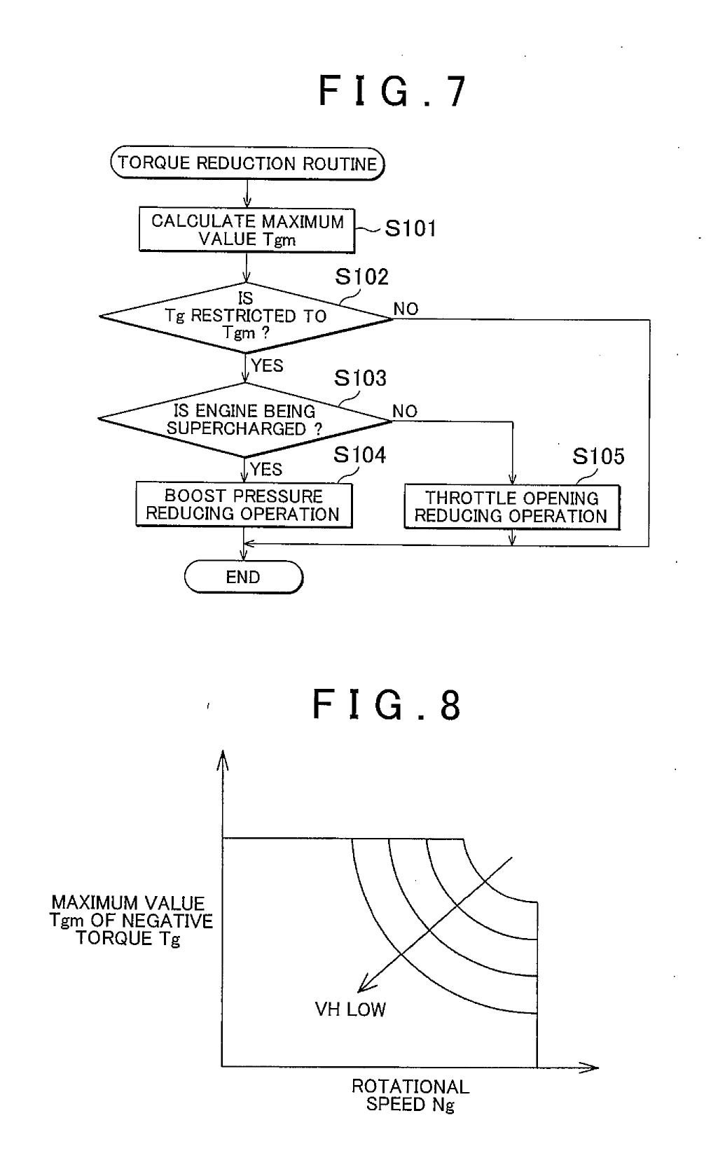

FIG. 7 is a flowchart illustrating a torque reduction routine for reducing the output torque Te of the engine 1 when the negative torque Tg applied from the first motor generator 4 to the engine 1 becomes equal to the maximum value Tgm. The torque reduction routine as an interrupt routine is periodically executed by the electronic control unit 15 at given time intervals.

In the routine of FIG. 7, the maximum value Tgm of the negative torque Tg of the first motor generator 4 is initially calculated (S101). In this step, the maximum value Tgm is calculated based on operating conditions of the first motor generator 4, such as the rotational speed Ng of the first motor generator 4, and boosted voltage VH used for operating the first motor generator 4. The thus calculated maximum value Tgm varies with the rotational speed Ng of the first motor generator 4, according to a pattern as indicated by one of solid lines in FIG. 8, and the pattern of variation of the maximum value Tgm changes as indicated by the arrow in FIG. 8 as the boosted voltage VH for operating the first motor generator 4 is reduced.

When the engine speed Ne deviates to the higher side from the target value Net, the negative torque Tg applied from the first motor generator 4 to the engine 1 is increased so as to reduce or eliminate the deviation. If the negative torque Tg increases and becomes equal to or larger than the maximum value Tgm, the negative torque Tg is restricted to the maximum value Tgm. In the operation of step S102 of the torque reduction routine, it is determined whether the negative torque Tg produced by the first motor generator 4 is restricted to the maximum value Tgm, in other words, whether the negative torque Tg becomes equal to the maximum value Tgm. If an affiunative decision (YES) is made in step S102, it is determined that the first motor generator 4 is in a high-load condition, and a series of operations (S103-S105) to reduce the output torque Te of the engine 1 are carried out.

In the series of operations, it is initially determined whether the internal combustion engine 1 is being supercharged by the turbocharger 21, based on the opening of the waste gate valve 24 (S103). More specifically, when the waste gate valve 24 is not in the fully opened condition, it is determined that the engine 1 is being supercharged by the turbocharger 21. In this case, a boost pressure reducing operation to reduce the boost pressure developed by the turbocharger 21 of the engine 1 is carried out (S104). In the boost pressure reducing operation, the opening of the waste gate valve 24 is adjusted to be increased, so that the boost pressure is reduced, whereby the output torque Te of the engine 1 is reduced. When the deviation of the engine speed Ne to the higher side from the target value Ne can be suppressed by applying the negative torque Tg of the first motor generator 4 to the engine 1, owing to the reduction of the output torque Te, the boost pressure is controlled through adjustment of the opening of the waste gate valve 24 so that the engine speed Ne is held at the target value Net. More specifically, the feedback control of the boost pressure is performed based on a deviation of the engine speed Ne from the target value Net, so that the deviation becomes equal to “0”.

In some cases, the deviation of the engine speed Ne to the higher side from the target value Net may not be suppressed, even in a condition where the output torque Te of the engine 1 is reduced by driving the waste gate valve 24 to the fully opened position and reducing the boost pressure down to the lowest possible level, through the above-described boost pressure reducing operation. In this case, the above deviation of the engine speed Ne from the target value Net cannot be suppressed even if the negative torque Tg (the maximum value Tgm) of the first motor generator 4 is applied to the engine 1.

In this condition, a negative decision (NO) is made in step S103 after an affirmative decision (YES) is made in step S102. As a result, a throttle opening reducing operation to reduce the throttle opening of the engine 1 is carried out (S105). In the throttle opening reducing operation, the opening of the throttle valve 26 is adjusted to be reduced, so that the output torque Te of the engine 1 is reduced. With the output torque Te thus reduced, the deviation of the engine speed Ne to the higher side from the target value Net can be suppressed by applying the negative torque Tg of the first motor generator 4 to the engine 1. If the deviation of the engine speed Ne from the target value Net can be suppressed in this manner, the throttle opening is controlled so that the engine speed Ne is held at the target value Net. More specifically, the feedback control of the throttle opening is performed based on a deviation of the engine speed Ne from the target value Net, so that the deviation becomes equal to “0”.

When the negative torque Tg applied from the first motor generator 4 to the engine 1 becomes equal to or larger than the maximum value Tgm, the operations of steps S103-S105 to reduce the output torque Te of the engine 1 are performed, so that the boost pressure reducing operation (S104) is carried out if the engine 1 is being supercharged, before the throttle opening reducing operation (S105) is carried out. As a result, after the boost pressure is reduced by adjusting the opening of the waste gate valve 24 to the larger degree in the boost pressure reducing operation, the throttle valve 26 is driven toward the closed position in the throttle opening reducing operation, so that the throttle opening is reduced. By reducing the throttle opening after reducing the boost pressure as described above, so as to reduce the output torque Te of the engine 1, the output torque Te of the engine 1 can be adequately reduced when the throttle opening is reduced.

The embodiment that has been described above in detail provides the following effects. (1) When the engine speed Ne deviates to the higher side from the target value Net, under the situation where the maximum value Tgm of the negative torque Tg is applied from the first motor generator 4 to the engine 1, and the first motor generator 4 that functions as a generator is in a high-load condition, the output torque Te of the engine 1 can be adequately reduced so as to reduce or eliminate the deviation. With the output torque Te of the engine 1 thus reduced, the first motor generator 4 is less likely to be or prevented from being brought into a high-load condition, and the rotational speed Ng of the first motor generator 4 is less likely to increase or prevented from increasing due to the high-load condition thereof. Accordingly, the maximum value Tgm of the negative torque Tg applied from the first motor generator 4 to the engine 1 is less likely to be or prevented from being reduced as the rotational speed Ng of the first motor generator 4 increases, and the above-described deviation of the engine speed Ne from the target value Net can be reduced or eliminated when the negative torque Tg is applied to the engine 1.

(2) When the output torque Te of the engine 1 is reduced through the boost pressure reducing operation and the throttle opening reducing operation, the throttle opening is reduced in the throttle opening reducing operation, after the boost pressure is reduced in the boost pressure reducing operation. Thus, the output torque Te of the engine 1 can be adequately reduced when the throttle opening is reduced.

(3) In the boost pressure reducing operation, when the deviation of the engine speed Ne to the higher side from the target value Net can be suppressed by reducing the boost pressure through adjustment of the opening of the waste gate valve 24 to the larger degree, the boost pressure is controlled through adjustment of the opening of the waste gate valve 24 so that the engine speed Ne is held at the target value Net. Accordingly, the engine speed Ne can be adequately made equal to the target value Net.

(4) In the throttle opening reducing operation, when the deviation of the engine speed Ne to the higher side from the target value Net can be suppressed by adjusting the opening of the throttle valve 26 to the smaller degree, the throttle opening is controlled so that the engine speed Ne is held at the target value Net. Accordingly, the engine speed Ne can be adequately made equal to the target value Net.

The illustrated embodiment may be modified as follows. While it is determined that the first motor generator 4 is in a high-load condition, based on a situation where the negative torque Tg of the first motor generator 4 is equal to the maximum value Tgm, the invention is not limited to this. For example, in view of the fact that the temperature of the first motor generator 4 increases as the load of the first motor generator 4 that functions as a generator is higher, it may be determined that the first motor generator 4 is in a high-load condition, based on a situation where the temperature of the first motor generator is equal to or higher than a given criterial value.

Regarding the coupling or connection of the three rotary elements, i.e., the planetary gear, sun gear, and the ring gear, in the planetary gear train of the power split device 2, with the engine 1, first motor-generator 4, and the drive shaft 3, combinations of these elements and components, other than those of the illustrated embodiment, may be employed.

The power split device 2 may consist of two or more planetary gear trains. While the feedback control, namely, control for adjusting the magnitude of negative torque Tg of the first motor generator 4 based on a difference between the engine speed Ne and the target value Net so that the engine speed Ne becomes close to or equal to the target value Net, is illustrated as driving control of the first motor generator 4 for regulating the engine speed Ne to the target value Net, the invention is not limited to this type of control. For example, open-loop control under which the first motor generator 4 is controlled without feedback of the engine speed Ne may be employed, as driving control of the first motor generator 4.

A variable capacity type turbocharger, or the like, may be employed as the supercharger. In this case, the boost pressure can be varied by varying the capacity of the turbocharger; therefore, the turbocharger also serves as a boost pressure varying mechanism, and the bypass passage 25 and the waste gate valve 24 need not be provided.

A mechanical supercharger, an electric supercharger, or the like, may be employed as the supercharger. When the mechanical supercharger is employed as the supercharger, a valve, or the like, that permits supercharged air delivered from the supercharger to escape from the intake system of the engine 1 may be provided as a boost pressure varying mechanism. When the electric supercharger is employed as the supercharger, the boost pressure can be varied by controlling driving of the supercharger; therefore, the supercharger also serves as a boost pressure varying mechanism.

While the invention is applied to a split-type hybrid vehicle, as a hybrid vehicle on which the motor and the internal combustion engine are installed as prime movers, in the illustrated embodiment, the invention may also be applied to a series-type hybrid vehicle, or a hybrid vehicle that can switch between a parallel type and a series type.

While the invention is applied to the vehicle having two motor generators in the illustrated embodiment, the invention may also be applied to a vehicle that includes only one motor generator, which functions as a motor or a generator as needed.

What is claimed is:

1. A control device for a hybrid vehicle on which an internal combustion engine equipped with a supercharger, and a motor generator that generates electric power while applying negative torque to the internal combustion engine, are installed, the internal combustion engine including a boost pressure varying mechanism operable to regulate a boost pressure developed by the supercharger, and a throttle valve operable to control a throttle opening thereof, comprising:
a controller configured to drive the boost pressure varying mechanism to reduce the boost pressure of the supercharger, before driving the throttle valve to reduce the throttle opening, in order to reduce output torque of the internal combustion engine, when the motor generator is in a high-load condition while negative torque applied from the motor generator to the internal combustion engine is adjusted so as to restrict an engine speed of the internal combustion engine to a target value.

2. The control device for the hybrid vehicle according to claim 1, wherein
the controller is configured to determine that the motor generator is in the high-load condition when the negative torque applied from the motor generator to the internal combustion engine is equal to a maximum value thereof.

3. The control device for the hybrid vehicle according to claim 1, wherein
the controller is configured to drive the boost pressure varying mechanism to reduce the boost pressure, so as to suppress a deviation of the engine speed to a higher side from the target value, when the motor generator is in the high-load condition; and
the controller is configured to drive the boost pressure varying mechanism so as to hold the engine speed at the target value, after the deviation of the engine speed to the higher side from the target value is suppressed due to reduction of the boost pressure.

4. The control device for the hybrid vehicle according to claim 1, wherein
when the motor generator is in the high-load condition, the controller is configured to drive the throttle valve to reduce the throttle opening, after driving the boost pressure varying mechanism to reduce the boost pressure.

5. The control device for the hybrid vehicle according to claim 4, wherein:
the controller is configured to drive the throttle valve to reduce the throttle opening, so as to suppress a deviation of the engine speed to a higher side from the target value, when the motor generator is in the high-load condition; and
the controller is configured to drive the throttle valve so as to hold the engine speed at the target value, after the deviation of the engine speed to the higher side from the target value is suppressed due to reduction of the throttle opening.

6. The control device for the hybrid vehicle according to claim 1, wherein:
the hybrid vehicle is equipped with a differential gear device including a planetary gear train comprising a planetary gear, a sun gear, and a ring gear, as three rotary elements, wherein one of the three rotary elements of the planetary gear train is coupled with the internal combustion engine such that rotary motion can be transmitted therebetween, and another one of the three rotary elements is coupled with the motor generator such that rotary motion can be transmitted therebetween, while a remaining one of the three rotary elements is coupled with a drive shaft of the vehicle such that rotary motion can be transmitted therebetween; and
the controller is configured to control a magnitude of the negative torque applied from the motor generator to the internal combustion engine so that the engine speed becomes equal to the target value.

7. A control method for a hybrid vehicle on which an internal combustion engine equipped with a supercharger, and a motor generator that generates electric power while applying negative torque to the internal combustion engine, are installed, comprising:
driving a boost pressure varying mechanism of the internal combustion engine so as to regulate a boost pressure developed by the supercharger of the internal combustion engine; and
driving a throttle valve of the internal combustion engine so as to adjust a throttle opening thereof, wherein
the boost pressure varying mechanism is driven to reduce the boost pressure of the supercharger, before the throttle valve is driven to reduce the throttle opening, in order to reduce output torque of the internal combustion engine, when the motor generator is in a high-load condition while negative torque applied from the motor generator to the internal combustion engine is adjusted so as to restrict an engine speed of the internal combustion engine to a target value.

8. The control method for the hybrid vehicle according to claim 7, further comprising
determining that the motor generator is in the high-load condition when the negative torque applied from the motor generator to the internal combustion engine is equal to a maximum value thereof.

9. The control method for the hybrid vehicle according to claim 7, wherein:
the boost pressure varying mechanism is driven to reduce the boost pressure, so as to suppress a deviation of the engine speed to a higher side from the target value, when the motor generator is in the high-load condition; and
the boost pressure varying mechanism is driven so as to hold the engine speed at the target value, after the deviation of the engine speed to the higher side from the target value is suppressed due to reduction of the boost pressure.

10. The control method for the hybrid vehicle according to claim 7, wherein
when the motor generator is in the high-load condition, the throttle valve is driven to reduce the throttle opening, after the boost pressure varying mechanism is driven to reduce the boost pressure.

11. The control method for the hybrid vehicle according to claim 10, wherein:
the throttle valve is driven to reduce the throttle opening, so as to suppress a deviation of the engine speed to a higher side from the target value, when the motor generator is in the high-load condition; and
the throttle valve is driven so as to hold the engine speed at the target value, after the deviation of the engine speed to the higher side from the target value is suppressed due to reduction of the throttle opening.

12. A control system for a hybrid vehicle on which an internal combustion engine equipped with a supercharger, and a motor generator that generates electric power while applying negative torque to the internal combustion engine, are installed, comprising:
a boost pressure varying mechanism configured to regulate a boost pressure developed by the supercharger;
a throttle valve configured to control a throttle opening thereof; and
a controller configured to drive the boost pressure varying mechanism to reduce the boost pressure of the supercharger, before driving the throttle valve to reduce the throttle opening, in order to reduce output torque of the internal combustion engine, when the motor generator is in a high-load condition while negative torque applied from the motor generator to the internal combustion, engine is adjusted so as to restrict an engine speed of the internal combustion engine to a target value.
